(19) United States
(12) Patent Application Publication
(10) Pub. No.: US 2010/0062886 A1
(43) Pub. Date: Mar. 11, 2010

(54) OIL FEED TYPE AUTO-TENSIONER

(76) Inventor: Ken Yamamoto, Shizuoka (JP)

Correspondence Address: WENDEROTH, LIND & PONACK, L.L.P., 1030 15th Street, N.W.,, Suite 400 East, Washington, DC, 20005-1503, US

(21) Appl. No.: 12/445,604

(22) PCT Filed: Nov. 15, 2007
(86) PCT No.: PCT/JP2007/072160

§ 371 Date: May 14, 2009

(30) Foreign Application Priority Data
Nov. 17, 2006 (JP) 2006-311543
Dec. 25, 2006 (JP) 2006-348070

(51) Int. Cl. F16H 7/08

(52) U.S. Cl. 474/110

(57) ABSTRACT

An object is to provide an oil feed type auto-tensioner which can reliably prevent air from mixing into hydraulic oil in the pressure chamber.

This tensioner includes a housing (11) defining a cylinder chamber (13), a plunger (14) slidably mounted in the cylinder chamber (13), a return spring (15) mounted in the cylinder chamber (13) and biasing the plunger (14) outwardly of the cylinder chamber (13), the housing (11) being formed with an oil supply passage (17) communicating with a pressure chamber (16) defined in the cylinder chamber behind the plunger (14), and a check valve (18) provided at a hydraulic oil outlet of the oil supply passage (17). The cylinder chamber (13) includes a large-diameter hole portion (19) provided at an open end thereof, in which a snap ring (20) for braking is received so as to be movable therein. The snap ring (20) includes a plurality of engaging pieces (20a) provided at a radially inner portion thereof and inclined in a direction in which the plunger (14) protrudes from the housing. The engaging pieces (20a) have radially inner edges that are in engagement with the outer periphery of the plunger, thereby restraining retraction of the plunger. When a pushing force is applied to the plunger (14) from the chain while the engine is at a stop, the snap ring (20) for braking abuts the closed end face of the large-diameter hole portion (19) and is stopped. In this state, because the radially inner edges of the engaging pieces (20a) formed on the radially inner portion of the snap ring (20) are in engagement with the outer periphery of the plunger (14), the plunger (14) is prevented from retracting, thus keeping the tension of the chain within a predetermined range. This prevents the plunger (14) from markedly moving outwardly when the engine is subsequently restarted.

### TECHNICAL FIELD

This invention relates to an oil feed type auto-tensioner for keeping constant the tension of a timing belt or a timing chain for driving camshafts.

### BACKGROUND ART

Typically, an auto-tensioner is used in a chain transmission device including a timing belt or a timing chain (hereinafter simply referred to as the “chain”) through which the engine rotation is transmitted to camshafts to keep the tension of the chain constant by applying its adjusting force to the slack side of the chain.

One known auto-tensioner of this type includes a housing, a plunger slidably inserted in a cylinder chamber defined in the housing for pressing the chain, and a return spring also mounted in the cylinder chamber and biasing the plunger outwardly of the cylinder chamber. The housing is formed with an oil supply passage communicating with a pressure chamber defined in the cylinder chamber behind the plunger. A check valve is provided at the hydraulic oil outlet of the oil supply passage. In this arrangement, a pushing force applied to the plunger from the chain is dampened by hydraulic oil supplied through the oil supply passage into the pressure chamber, while the chain is tensioned by pressing the plunger against the chain under the force of the return spring.

In such an oil feed type auto-tensioner, if the slack side of the chain is tensioned when the engine is stopped according to the stopped positions of the cams, the plunger is pushed in under the load applied from slack side of the chain to its stroke end.

When the engine is subsequently restarted in this state, the slack side of the chain slackens markedly, so that the plunger moves quickly outwardly under the force of the return spring to re-tension the chain. Since the plunger moves a long distance at this time, the volume of the pressure chamber increases quickly and markedly, which in turn causes a sudden and sharp drop in pressure in the pressure chamber. Such a sharp pressure drop causes separation of air dissolved in hydraulic oil, and/or sucks outer air into the pressure chamber, thereby deteriorating the hydraulic damper function of the tensioner.

One effective way to solve this problem is to provide a mechanism for restricting the retraction of the plunger, as disclosed in Patent documents 1 to 3. In the oil feed type auto-tensioner disclosed in Patent document 1, the retraction of the plunger is prevented by engaging a pivotable ratchet provided on the housing with a rack formed on the outer periphery of the plunger.

In the oil feed type auto-tensioner disclosed in Patent document 2, the plunger is formed with a threaded hole having a rear open end, and a screw rod having an external thread on its outer periphery is in threaded engagement with the internal thread of the threaded hole. Both the external thread of the screw rod and the internal thread of the threaded hole have a serration-shaped axial section. In this arrangement, the retraction of the plunger is prevented by the friction produced between the contact surfaces of the pressure flanks of the respective serration-shaped threads.

In the oil feed type auto-tensioner disclosed in Patent document 3, a guide groove is formed in the inner periphery of a cylinder chamber defined in the housing, with a register ring fitted in the guide groove, and a plurality of circumferential grooves are formed in the outer periphery of the plunger so that the register ring can be tightly fitted in any of the circumferential grooves. Each circumferential groove comprises a tapered surface and an engaging surface extending from the small-diameter end of the tapered surface. In this arrangement, the retraction of the plunger is prevented by engaging the register ring with the engaging surface.

Patent document 1: JP Utility Model Publication 251627
Patent document 2: JP Patent Publication 3748656B
Patent document 3: JP Patent Publication 3670911B

### DISCLOSURE OF THE INVENTION

### Object of the Invention

In the oil feed type auto-tensioner disclosed in Patent document 1, if the plunger protrudes excessively from the cylinder chamber due to excessive vibration of the chain, the plunger cannot retract sufficiently thereafter when the engine speed subsequently drops, thus resulting in cutting of the chain due to over-tensioning or damage to the ratchet. Also, because it is necessary to form the rack on the outer periphery of the plunger, the manufacturing cost is high.

In the oil feed type auto-tensioner disclosed in Patent document 2, if the chain is over-tensioned, slip occurs between the contact surfaces of the respective pressure flanks due to dynamic loads applied to the plunger, allowing retraction of the plunger, and thus preventing over-tensioning of the chain. But forming the serration-shaped threads is troublesome and thus the manufacturing cost is high, as with the auto-tensioner disclosed in Patent document 1.

In the oil feed type auto-tensioner disclosed in Patent document 3, as with the auto-tensioner disclosed in Patent document 1, because the plunger cannot be retracted, the chain may be over-tensioned. Also, it is troublesome to form the circumferential grooves in the outer periphery of the plunger, and thus the manufacturing cost is high.

An object of the present invention is to provide a low-cost oil feed type auto-tensioner which can reliably prevent air from being mixed into the pressure chamber.

### Means to Achieve the Object

In order to achieve this object, the present invention provides an oil feed type auto-tensioner comprising a housing defining a cylinder chamber, a plunger slidably mounted in the cylinder chamber for pressing a chain, a return spring mounted in the cylinder chamber and biasing the plunger outwardly of the cylinder chamber, the housing being formed with an oil supply passage communicating with a pressure chamber defined in the cylinder chamber behind the plunger, and a check valve provided at a hydraulic oil outlet of the oil supply passage, characterized in that the cylinder chamber includes a large-diameter hole portion provided at an open end thereof, that the auto-tensioner further comprises a snap ring for braking received in the large-diameter hole portion so as to be movable therein, the snap ring including a plurality of engaging pieces provided at a radially inner portion thereof and inclined in a direction in which the plunger protrudes from the housing, the engaging pieces having radially inner edges that are in engagement with the outer periphery of the plunger, thereby restraining retraction of the plunger, and a stopper provided at an open end of the large-diameter hole portion, the stopper being configured to prevent separation of the snap ring, and configured, in cooperation with a closed end face of the large-diameter hole portion, to restrict the axial movement of the snap ring.

In this oil feed type auto-tensioner, if the chain is tensioned when the engine is stopped according to the stopped positions of the cams, and a pushing force is applied to the plunger from the chain, the snap ring for braking is pushed in together with the plunger until abutting the closed end of the large-diameter hole portion, and kept in this position. In this state, the engaging pieces of the snap ring for braking engage at their radially inner edges with the outer periphery of the plunger, thereby keeping the plunger stationary.

Thus, the slack side of the chain remains tensioned, though its tension may slightly decrease, so that when the engine is subsequently restarted, the slack side of the chain never slackens markedly. Also, because the plunger does not markedly move outwardly, the pressure in the pressure chamber does not markedly drop. This prevents separation of air dissolved in the hydraulic oil or outer air from being sucked into the pressure chamber, thus preventing air from being mixed into the hydraulic oil in the pressure chamber.

The stopper may comprise a snap ring fitted to the inner periphery of the large-diameter hole portion, or an anti-separation ring having a radially outer cylindrical portion fitted on the outer periphery of the housing at the end thereof.

In the oil feed type auto-tensioner according to this invention, when the chain or the oil feed type auto-tensioner is dismounted for maintenance of the engine or its peripheral parts, the plunger could slide outwardly under the force of the return spring, and come out of the housing. If the plunger does come out of the housing, internal parts may scatter and be lost.

Thus, the tensioner of this invention preferably further comprises a radially elastically deformable stopper ring provided between the closed end of the large-diameter hole portion and the snap ring for braking, the stopper ring being fitted around the plunger in a radially expanded state so as to be in elastic contact with the cylindrical outer periphery of the plunger, whereby the stopper ring is prevented from coming out of the large-diameter hole portion by abutting the engaging pieces of the snap ring for braking, wherein the plunger has an annular anti-separation groove formed in the outer periphery of its rear end portion in which the stopper ring is engageable by being radially compressed, thereby preventing separation of the plunger.

### ADVANTAGES OF THE INVENTION

According to the present invention, when the tension of the slack side of the chain increases when the engine is stopped, the snap ring for braking abuts the closed end of the large-diameter hole portion and is stopped. In this state, because the engaging pieces of the snap ring for braking engage at their radially inner edges with the outer periphery of the plunger, the plunger is also kept stopped. Thus, the plunger is never pushed in beyond the necessary extent, so that the tension of the chain is kept within a predetermined range.

Thus, when the engine is subsequently restarted, the slack side of the chain never slackens markedly. Also, because the plunger moves outwardly only for a short distance, the pressure in the pressure chamber never drops markedly, thus reliably preventing air from being mixed into the hydraulic oil in the pressure chamber.

The arrangement comprising the large-diameter hole and the snap ring for braking having engaging pieces and mounted in the large-diameter hole is simple in structure. No machining is necessary on the outer periphery of the plunger. Thus, the oil feed type auto-tensioner according to the present invention is provided at a low cost.

### BRIEF DESCRIPTION OF THE DRAWINGS

FIG. 1 is a vertical sectional front view of an oil feed type auto-tensioner embodying the present invention.

FIG. 2 is an enlarged sectional view of the auto-tensioner of FIG. 1, showing its portion where a snap ring for braking is mounted.

FIG. 3(I) is a partial enlarged sectional view of the auto-tensioner of FIG. 1, showing its portion where the snap ring for braking is mounted; FIG. 3(II) is a view similar to FIG. 3(I) and showing the state where the plunger has been pushed in; and FIG. 3(III) is a similar to FIG. 3(I) and showing the state where the plunger has advanced.

FIG. 4 is a right-hand side view of FIG. 1.

FIG. 5 is a graph showing moving directions of the plunger according to the engine conditions.

FIG. 6 is a graph showing the displacement of the plunger while the engine is running.

FIG. 7 is a graph showing maximum and minimum values of the force applied to the oil feed type auto-tensioner during engine sweep.

FIG. 8 is a graph showing the axial displacement of the plunger during engine sweep.

FIG. 9 is a sectional view of an oil feed type auto-tensioner according to another embodiment of the present invention.

FIG. 10 is a sectional view of an oil feed type auto-tensioner according to still another embodiment of the present invention.

FIG. 11 is a sectional view showing how the plunger is prevented from coming out of the housing.

FIG. 12 is a sectional view of an oil feed type auto-tensioner according to yet another embodiment of the present invention.

### DESCRIPTION OF THE NUMERALS

11. Housing
13. Cylinder chamber
14. Plunger
15. Return spring
16. Pressure chamber
17. Oil supply passage
18. Check valve
19. Large-diameter hole portion
20. Snap ring for braking
20a. Engaging piece
21. Snap ring (stopper)
22. Anti-separation ring (stopper)
22a. Cylindrical portion
23. Stopper ring
25. Anti-separation groove

### BEST MODE FOR EMBODYING THE INVENTION

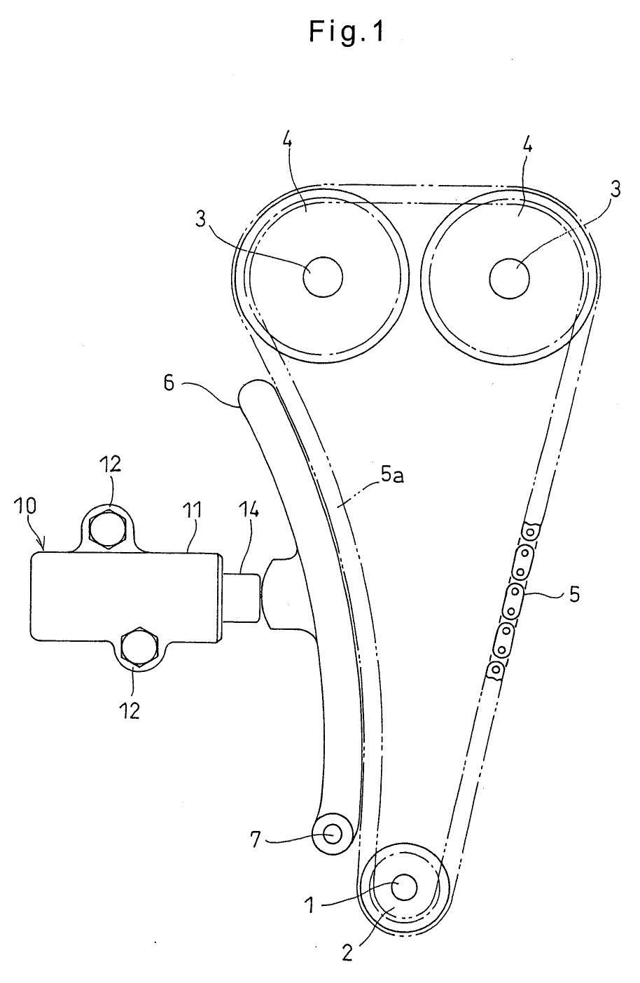

The embodiments of this invention are now described with reference to the drawings. FIG. 1 shows a chain tension adjusting device for adjusting the tension of a chain for driving camshafts. This device includes a sprocket 2 mounted to an end of a crankshaft 1, sprockets 4 each mounted to an end of one of camshafts 3, and a chain 5 trained around the sprockets 2 and 4. A chain guide 6 is provided on the slack side of the chain 5.

The chain guide 6 has its bottom end supported by the shaft 7 so as to be pivotable about the shaft 7. The chain guide 6 is pressed against the chain by an adjusting force applied to the chain guide 6 from an oil feed type auto-tensioner 10.

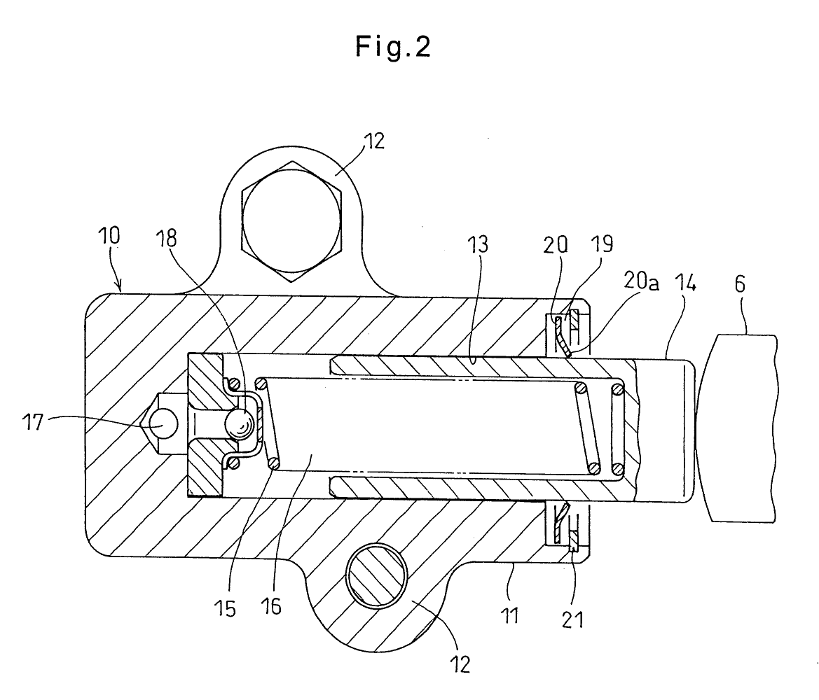

As shown in FIG. 2, the oil feed type auto-tensioner includes a housing 11. As shown in FIG. 1, the housing 11 has mounting pieces 12 on its outer periphery which are bolted to an engine block. The housing 11 defines a cylinder chamber 13 having an opening at one end of the housing 11. A plunger 14 is slidably mounted in the cylinder chamber 13 and is biased outwardly of the housing 11 by a return spring 15 which is also mounted in the cylinder chamber 13.

The housing 11 is formed with an oil supply passage 17 communicating with a pressure chamber 16 defined behind the plunger 14. A check valve 18 is mounted at the hydraulic oil outlet of the oil supply passage 17. The check valve 18 closes the oil supply passage 17 when the pressure in the pressure chamber 16 exceeds the pressure of hydraulic oil in the oil supply passage 17.

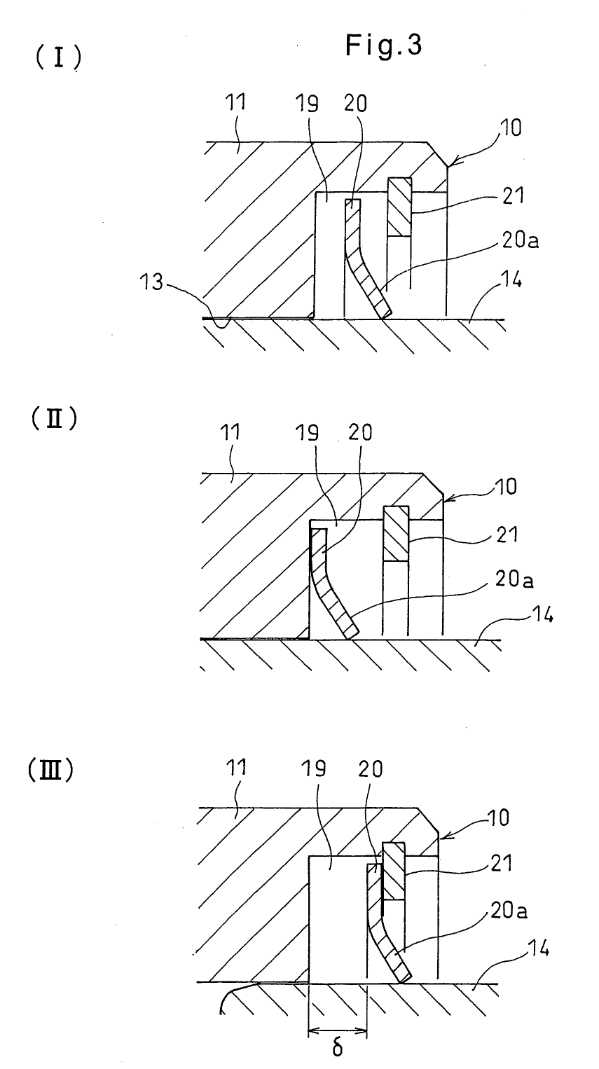

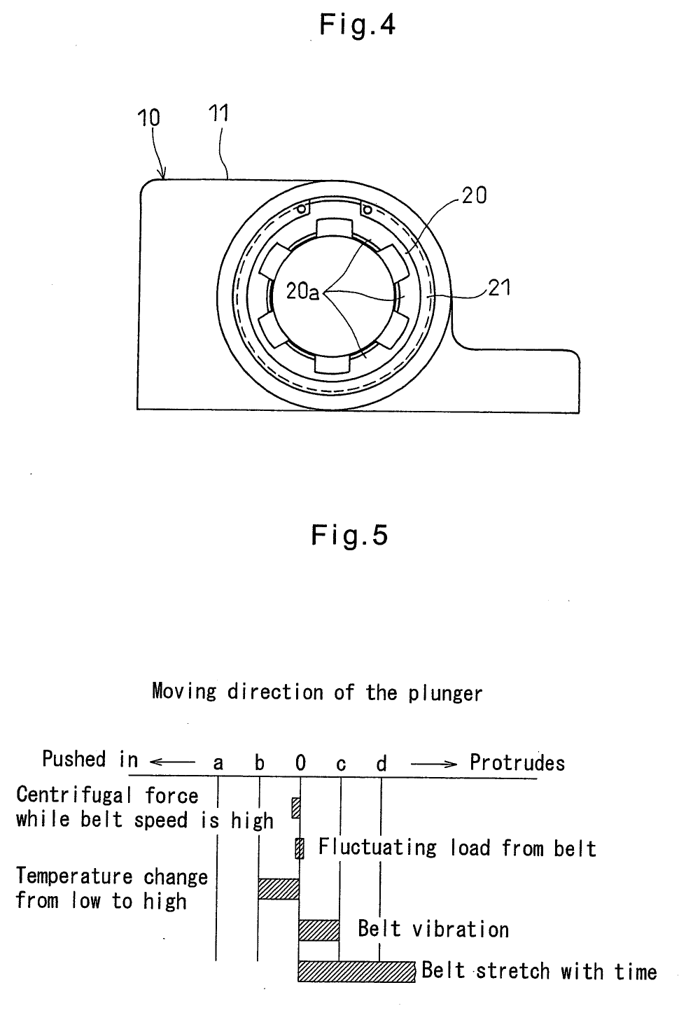

As shown in FIGS. 2 and 3, the cylinder chamber 13 includes a large-diameter hole portion 19 formed at its open end portion. In the hole portion 19, a snap ring 20 for braking is fitted. Another snap ring 21 is fitted in the large-diameter hole portion 19 at its open end. The snap ring 21 serves as a stopper for preventing separation of the snap ring 20. The snap ring 20 for braking is axially movable within the axial gap 6 defined between the snap ring 21 and the closed end surface of the large-diameter hole portion 19.

The snap ring 20 for braking has a plurality of engaging pieces 20a on its radially inner surface that are inclined in the direction in which the plunger 14 protrudes and have their tips resiliently pressed against the outer periphery of the plunger 14. When a load is applied to the plunger 14 that tends to push the plunger 14 into the housing, the engaging pieces 20a engage the outer periphery of the plunger 14 at their tips, thereby suppressing the backward movement of the plunger 14.

Now the operation of this oil feed type auto-tensioner is described. In the state of FIG. 1, the tension of the chain 5 fluctuates due to fluctuations in load and angular velocity of the crankshaft. When the slack side 5a of the chain 5 slackens, the plunger 14 is pushed out of the housing by the return spring 15, thereby absorbing slackness.

When the tension of the slack side 5a of the chain 5 increases, a pushing force is applied to the plunger 14 from the slack side 5a of the chain 5. This pushing force is dampened by hydraulic oil in the pressure chamber 16.

When this pushing force exceeds the elastic force of the return spring 15, hydraulic oil in the pressure chamber 16 flows through a narrow leak gap defined between the sliding surfaces of the cylinder chamber 13 and the plunger 14 to outside. Thus, the plunger 14 slowly retracts until the pushing force balances with the elastic force of the return spring 15. The tension of the chain 5 is thus kept constant.

While the tension of the chain 5 is being adjusted in this manner, the snap ring 20 for braking moves together with the plunger 14. When the chain 5 is stretched with the passage of time, the plunger 14 moves outwardly of the housing under the force of the return spring 15. When the plunger 14 moves in this direction, the snap ring 20 for braking moves together with the plunger 14 until it abuts the snap ring 21 as a stopper as shown in FIG. 3(III). Thereafter, the plunger 14 moves further in this direction while elastically and radially outwardly deforming the engaging pieces 20a of the snap ring 20, thereby absorbing slackness of the stretched chain 5.

When the engine is stopped, the slack side 5a of the chain 5 may be kept tensioned according to the stopped positions of the cams. In this state, because a pushing force is applied from the slack side 5a of the chain 5 to the plunger 14, the snap ring 20 for braking is pushed in together with the plunger until it abuts the closed end surface of the large-diameter hole portion 19 and stops as shown in FIG. 3(II). In this state, the tips of the engaging pieces 20a of the snap ring 20 for braking engage the outer periphery of the plunger 14, thereby keeping the plunger 14 stopped.

Thus, since the slack side 5a of the chain 5 is kept tensioned, though its tension may somewhat decrease, when the engine is subsequently restarted, the slack side 5a of the chain 5 never slackens markedly, so that the plunger 14 is not markedly moved outwardly, and thus the pressure drop in the pressure chamber 16 is minimum. This prevents separation of air dissolved in the hydraulic oil in the pressure chamber 16, suction of outer air into the pressure chamber 16, or mixing of air into the hydraulic oil in the pressure chamber 16.

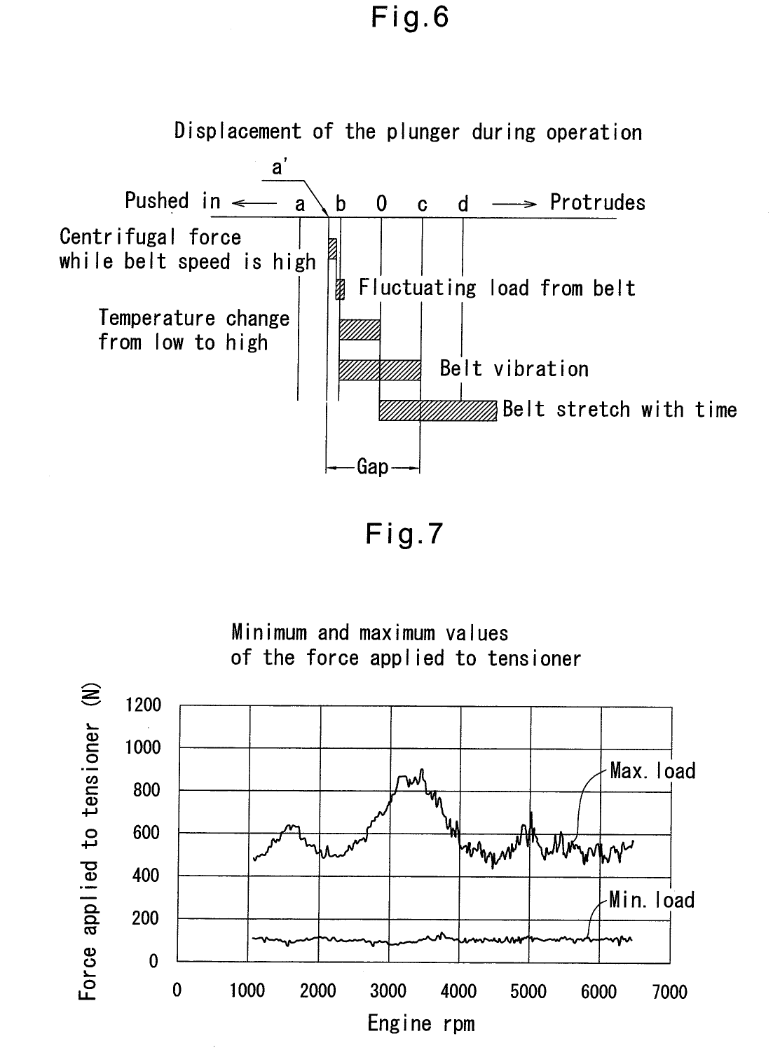

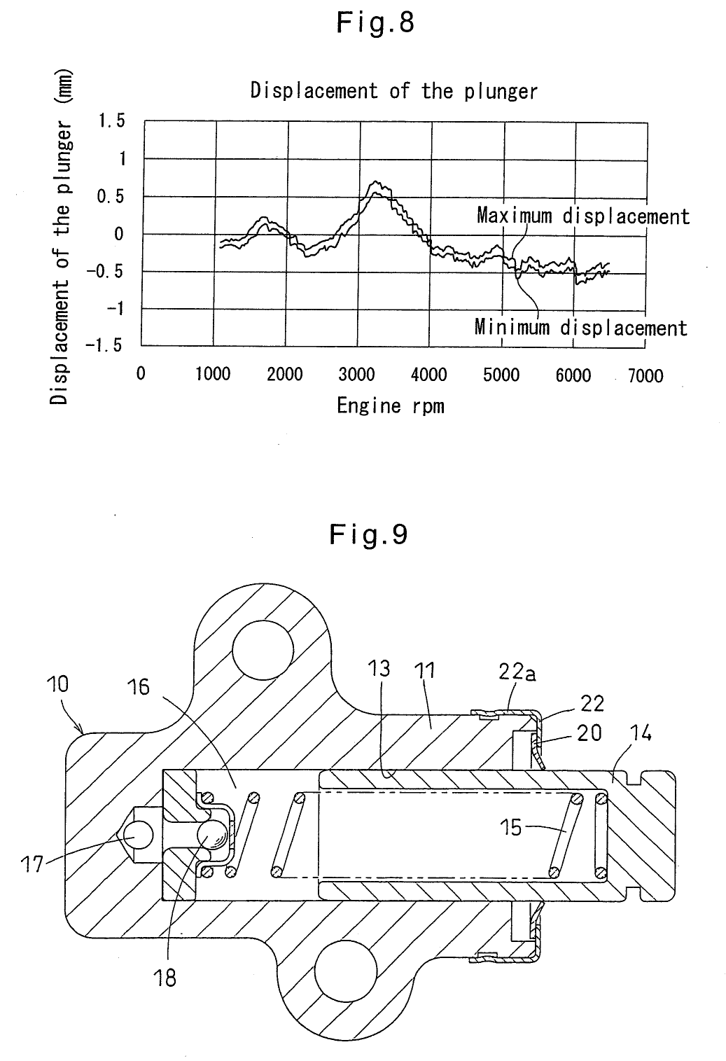

FIG. 5 shows the direction of axial movement of the plunger 14 according to the engine condition. FIG. 6 shows the necessary axial dimension of the gap δ between the snap ring 20 for braking and the closed end face of the large-diameter hole portion 19 when the engine is running under the conditions of FIG. 5. FIG. 7 shows maximum and minimum values of the force applied to the oil feed type auto-tensioner during engine sweep. FIG. 8 shows axial displacement of the plunger 14 during engine sweep.

Of FIGS. 5 to 8, FIG. 7 shows, as one example, that the maximum values of the load applied to the oil feed type auto-tensioner on the high-speed and low-speed sides are substantially equal to each other. But as shown in FIG. 8, the plunger 14 is pushed in slightly more markedly on the high-speed side than on the low-speed side. This is because while the engine is rotating at a high speed, the chain 5 expands radially from its initial orbit due to centrifugal force, and the plunger 14 is pushed in by the slack side 5a of the chain 5.

When the camshafts rotate, the valve spring load is applied twice per rotation of the crankshaft 1 from the chain 5 to the oil feed type auto-tensioner. Its maximum value varies with engine rpm as shown in FIG. 7. This load tends to increase when the chain 5 vibrates due to resonance. The plunger 14 protrudes to reduce such vibration (at around 3200 r/min.).

The plunger 14 is also pushed in when the distance between the axes of the crankshaft and the camshafts increases due to temperature change.

As the chain 5 is stretched with the passage of time, the plunger 14 protrudes.

FIG. 6 shows the range of displacement of the plunger 14 while the engine is running under the above conditions. As shown, the plunger is displaced within the range of a' to c. Thus, by setting the axial dimension of the gap δ to a value equal to the range of a' to c, the snap ring 20 for braking can move without abutting the closed end face of the large-diameter hole portion 19 while the engine is running, which in turn prevents large loads as shown in FIG. 7 from being applied to the snap ring 20 for braking.

As the chain 5 is stretched with the passage of time, the plunger 15 gradually protrudes under the force of the return spring 15. But in this case, because the resistance is small and the moving distance is extremely short, there is no detrimental influence on the characteristics of the tensioner.

Conversely, when the plunger 14 is pushed in by a distance greater than the axial dimension of the gap δ due to disturbances, since the snap ring 20 for braking is not locked, the plunger 14 is pushed in if the load applied is larger than the set value, thus preventing over-tensioning of the chain.

When the engine is stopped, according to the phases of the cams, the slack side 5a of the chain 5 may be tensioned under the force of valve springs that push up some of the cams. In case of a four-cylinder engine, one or two of the cylinders are always in the intake stroke. Thus, the valve springs corresponding to the cylinder or cylinders that are in the intake stroke push up the corresponding cams. The force of these valve springs is reduced to half when it is applied to the chain due to the difference in radium between the cams and the corresponding pulley, and could be further reduced according to the winding angle of the pulley.

Since the return spring 15 is mounted in the oil feed type auto-tensioner, the difference between the tension of the slack side of the chain and the force of the return spring 15 acts as a pushing force on the plunger 14. Typically, the valve spring load of a four-cylinder engine is a maximum of about 300 N, while the force of the return spring 15 is about 100 N as shown in FIG. 7 at “Min load”. Thus, the tension of the chain when the engine is stopped is about 100 to 200 N, which means that a pushing force of about 100 N, which is the difference between the above-mentioned tension of the chain and the load of the return spring 15, acts as a pushing force on the plunger 14. It is considered that an ordinary snap ring can sufficiently cope with such a pushing force.

In the embodiment shown in FIG. 2, the snap ring 21 is fitted in the large-diameter hole portion 19 near its open end to prevent separation of the snap ring 20 for braking. But instead, as shown in FIG. 9, a cylindrical portion 22a of a anti-separation ring 22 may be fitted on the outer periphery of the housing 11 at its end and crimped with the anti-separation ring 22 in abutment with the end face of the housing 11, thereby preventing separation of the snap ring 20 for braking.

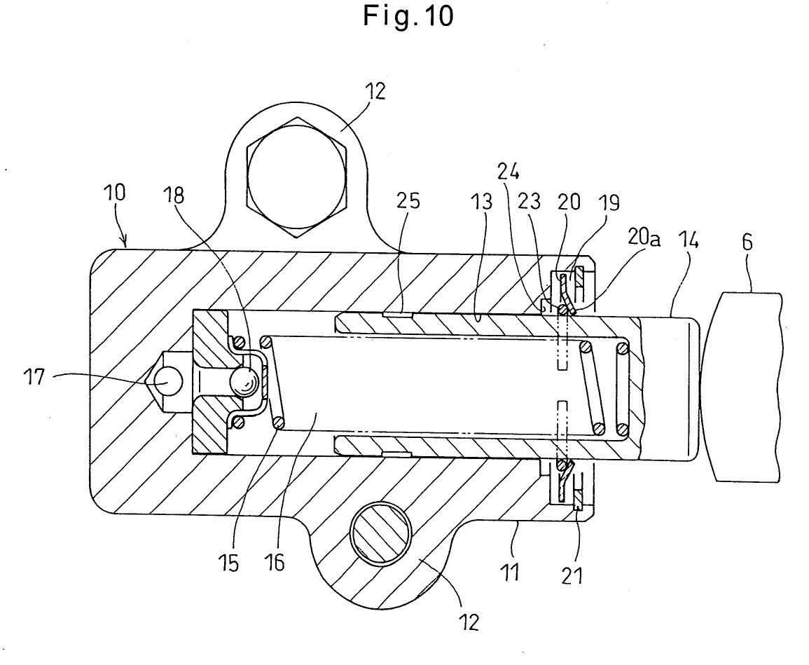

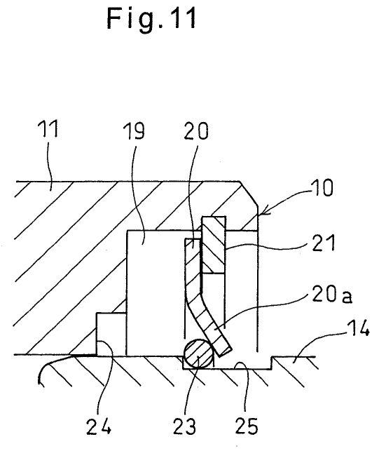

FIGS. 10 and 11 show a different oil feed type auto-tensioner embodying the present invention. In this embodiment, between the closed end of the large-diameter hole portion 19, which is formed in the cylinder chamber 13 at its open end, and the snap ring 20 for braking, a radially elastically deformable stopper ring 23 is fitted around the plunger 14 in a radially expanded state so as to be in elastic contact with the cylindrical outer periphery of the plunger 14. The stopper ring 23 is prevented from coming out of the large-diameter hole portion 19 by abutting the engaging pieces 20a of the snap ring 20.

In the closed end of the large-diameter hole portion 19, a small-diameter recess 24 is formed in which the stopper ring 23 can be received. An annular anti-separation groove 25 is formed in the outer periphery of the plunger 14 at its rear end portion in which the stopper ring 23 is engageable while being radially compressed. The depth of the anti-separation groove 25 is smaller than the line diameter of the stopper ring 23.

Otherwise, this embodiment is identical to the oil feed type auto-tensioner shown in FIG. 2. Thus, like elements are denoted by identical numerals and their description is omitted.

As described above, by mounting the radially elastically deformable stopper ring 23 between the snap ring 20 for braking and the closed end face of the large-diameter hole portion 19 so as to be in elastic contact with the cylindrical outer periphery of the plunger 14, and further forming the anti-separation groove 25 in the outer periphery of the plunger 14 at its rear end portion, when the chain 5 or the oil feed type auto-tensioner is dismounted for maintenance of the engine or its peripheral parts, the plunger 14 never comes out of the housing 11.

For example, if the oil feed type auto-tensioner 10 is dismounted, the plunger 14 slides outwardly under the force of the return spring 15 until the stopper ring 23 abuts the engaging pieces 20a of the snap ring 20 for braking. The engaging pieces 20a thus prevent separation of the stopper ring 23. Thereafter, only the plunger 14 slides outwardly relative to the stopper ring 23.

When the plunger 14 moves outwardly until the anti-separation groove 25, which is formed in the outer periphery of the plunger 14 at its rear end portion, radially faces the stopper ring 23, the stopper ring 23 is radially compressed by its elasticity and fitted in the anti-separation groove 25. In this state, as shown in FIG. 11, the stopper ring 23 abuts the rear end face of the anti-separation groove 25 relative to the moving direction of the groove 25, thereby preventing separation of the plunger 14.

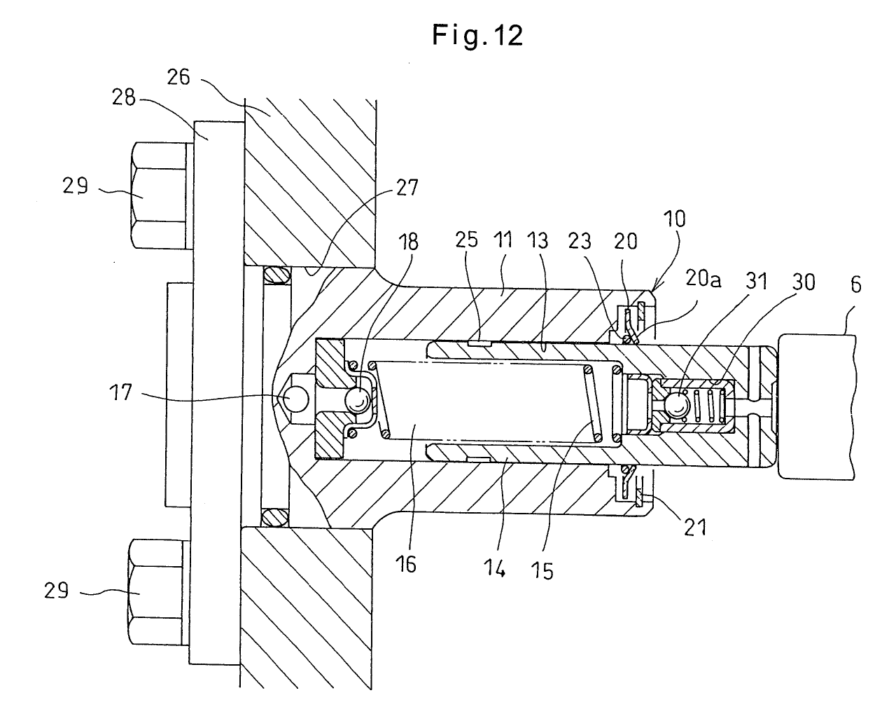

The oil feed type auto-tensioners 10 shown in FIGS. 2 and 10 are both tensioners of the internally mounted type, in which the housing 11 is fixed to an engine block. But the oil feed type auto-tensioner 10 according to the present invention is not limited to this type but may be of the externally mounted type, in which, as shown in FIG. 12, the housing 11 is inserted in a tensioner mounting hole 27 formed in a chain cover 26, and a flange 28 formed at the rear end of the housing 11 is fixed to the chain cover 26 by tightening bolts 29.

In the auto-tensioner 10 shown in FIG. 12, the plunger 14 has a pressure relief hole 30 formed near the front end thereof through which the pressure chamber 16 communicates with the outside. A relief valve 31 is mounted in the pressure relief hole 30.

With this arrangement, if the plunger 14 is pushed in and the pressure in the pressure chamber 16 exceeds a set pressure of the relief valve 31, the relief valve 31 opens, thus releasing pressure in the pressure chamber to the outside through the pressure relief hole 30, which in turn prevents over-tensioning of the chain 5.

1. An oil feed type auto-tensioner comprising a housing defining a cylinder chamber, a plunger slidably mounted in the cylinder chamber for pressing a chain, a return spring mounted in the cylinder chamber and biasing said plunger outwardly of the cylinder chamber, said housing being formed with an oil supply passage communicating with a pressure chamber defined in said cylinder chamber behind said plunger, and a check valve provided at a hydraulic oil outlet of said oil supply passage,
characterized in that said cylinder chamber includes a large-diameter hole portion provided at an open end thereof, that the auto-tensioner further comprises a snap ring for braking received in said large-diameter hole portion so as to be movable therein, said snap ring including a plurality of engaging pieces provided at a radially inner portion thereof and inclined in a direction in which said plunger protrudes from the housing, said engaging pieces having radially inner edges that are in engagement with the outer periphery of the plunger, thereby restraining retraction of the plunger, and a stopper provided at an open end of said large-diameter hole portion, said stopper being configured to prevent separation of said snap ring, and configured, in cooperation with a closed end face of the large-diameter hole portion, to restrict the axial movement of said snap ring.

2. The oil feed type auto-tensioner of claim 1 wherein said stopper comprises a snap ring fitted to the inner periphery of the large-diameter hole portion.

3. The oil feed type auto-tensioner of claim 1 wherein said stopper is an anti-separation ring having a radially outer cylindrical portion fitted on the outer periphery of the housing at the end thereof.

4. The auto-tensioner of any of claim 1 further comprising a radially elastically deformable stopper ring provided between the closed end of said large-diameter hole portion and said snap ring for braking, said stopper ring being fitted around said plunger in a radially expanded state so as to be in elastic contact with the cylindrical outer periphery of said plunger, whereby said stopper ring is prevented from coming out of the large-diameter hole portion by abutting the engaging pieces of said snap ring for braking, wherein said plunger has an annular anti-separation groove formed in the outer periphery of its rear end portion in which the stopper ring is engageable by being radially compressed, thereby preventing separation of the plunger.

5. The auto-tensioner of claim 2 further comprising a radially elastically deformable stopper ring provided between the closed end of said large-diameter hole portion and said snap ring for braking, said stopper ring being fitted around said plunger in a radially expanded state so as to be in elastic contact with the cylindrical outer periphery of said plunger, whereby said stopper ring is prevented from coming out of the large-diameter hole portion by abutting the engaging pieces of said snap ring for braking, wherein said plunger has an annular anti-separation groove formed in the outer periphery of its rear end portion in which the stopper ring is engageable by being radially compressed, thereby preventing separation of the plunger.

6. The auto-tensioner of claim 3 further comprising a radially elastically deformable stopper ring provided between the closed end of said large-diameter hole portion and said snap ring for braking, said stopper ring being fitted around said plunger in a radially expanded state so as to be in elastic contact with the cylindrical outer periphery of said plunger, whereby said stopper ring is prevented from coming out of the large-diameter hole portion by abutting the engaging pieces of said snap ring for braking, wherein said plunger has an annular anti-separation groove formed in the outer periphery of its rear end portion in which the stopper ring is engageable by being radially compressed, thereby preventing separation of the plunger.
